(19) United States
(12) Patent Application Publication
(10) Pub. No.: US 2009/0194116 A1
(43) Pub. Date: Aug. 6, 2009

(54) Nipple guard and strap for a nursing female

(76) Inventor: Larry W. Pacini, Costa Mesa, CA (US)

Correspondence Address: Morland C. Fischer, Suite 1300, 2030 Main Street, Irvine, CA, 92614, US

(21) Appl. No.: 12/012,566

(22) Filed: Feb. 5, 2008

(51) Int. Cl. A61J 13/00

(52) U.S. Cl. 128/890

(57) ABSTRACT

A nipple guard to be worn over and against the breast of a nursing mother to reduce discomfort caused by the biting and/or hard sucking of a nursing newborn. The nipple guard includes a breast cup that is sized and shaped to fit over the mother's breast. A flexible strap connected to the nipple guard is of sufficient length to run completely around the back of the mother and apply a pulling force to hold the breast cup against the mother's breast. A resilient ring extends around the periphery of the breast cup to cushion the force of the breast cup being pulled against the mother's breast. A hole is formed through the breast cup to receive the mother's nipple, and a cylindrical sucking tube communicates with the hole and projects from the breast cup. The sucking tube surrounds and protects the mother's nipple, such that a natural sucking force generated by the nursing newborn is applied to the nipple via the tube. The nipple guard is ideally suited to be worn below a conventional nursing bra.

### BACKGROUND OF THE INVENTION

1. Field of the Invention

This invention relates to a comfortable nipple guard to be worn over and against the breast of a mother to reduce nipple discomfort caused by the biting and/or hard sucking of a nursing newborn. A strap connected to the nipple guard runs behind the mother's back to hold the nipple guard in engagement with her breast.

2. Background Art

Nursing mothers are often subjected to nipple discomfort and even injury over time as a result of prolonged biting and/or hard sucking by her newborn. As a consequence of such discomfort, some mothers may choose to give up nursing altogether. In this case, the newborn may be denied the benefits known to be associated with breast feeding. In other cases, the mother may choose to delay nursing during the day which may cause her newborn to become unnecessarily hungry and resort to crying.

Accordingly, what is desirable is a comfortable, easy-to-use, hands-free nipple guard to be worn by mothers over their breasts to shield their nipples from discomfort and possible injury often caused by biting and hard sucking infants so as not to interfere with the normal breast feeding process.

### SUMMARY OF THE INVENTION

Briefly, and in general terms, a nipple guard is disclosed to be worn by a mother over her breast to shield her nipple from discomfort and possible injury often caused by the biting and/or hard sucking of a nursing newborn. The nipple guard includes a soft breast cup that is sized and shaped to receive and surround the front of the mother's breast. A resilient peripheral ring that extends around the bottom of the breast cup lies against the mother's breast to cushion the pressure applied to the breast at those times when the nipple guard is worn.

In this regard, first and opposite ends of a cup-retaining strap are attached to the breast cup through respective slits made therein. The cup-retaining strap is preferably manufactured from an elastic material that is adapted to stretch. The strap is sized to run under one arm of the mother, behind her back, and around one side of her neck so as to hold the breast cup in place over and against her breast to advantageously enable a hands-free use of the nipple guard.

A hole is formed through the breast cup of the nipple guard. A cylindrical tube is co-extensively connected to and projects outwardly from the breast cup so as to communicate with the hole. The cylindrical tube has a longitudinal axis that makes a small angle with a transverse centerline through the breast cup. The cylindrical tube has a length and diameter so as to surround and protect the mother's nipple, such that a natural sucking force generated by the newborn will be applied to the nipple via the tube to permit the newborn to nurse. Accordingly, the nipple guard of this invention is capable of enclosing the mother's breast with the outwardly projecting tube being angled and positioned on the breast cup to correspond with the angle and position of the mother's nipple relative to her breast. To this end, the nipple guard is ideally suited to be worn under a conventional nursing bra.

### BRIEF DESCRIPTION OF THE DRAWINGS

FIG. 1 shows a nipple guard according to a preferred embodiment of this invention held over and against the breast of a nursing mother by means of a strap connected to a breast cup thereof;

FIG. 2 is a front perspective view of the nipple guard shown in FIG. 1;

FIG. 3 is a rear elevational view of the nipple guard;

FIG. 4 is a top plan view of the nipple guard;

FIG. 5 is a cross section of the nipple guard taken along lines 5-5 of FIG. 4; and

FIG. 6 shows the nipple guard of this invention being worn over the breast of a nursing mother and under a conventional nursing bra.

### DESCRIPTION OF THE PREFERRED EMBODIMENT

Referring initially to FIG. 1 of the drawings, there is shown a nipple guard 1 according to a preferred embodiment of the present invention to be worn by a nursing mother of a newborn. As will soon be explained, the nipple guard 1 protects the nursing mother's nipple against biting and/or hard sucking by her newborn. By virtue of the foregoing, breast feeding will be encouraged without subjecting the mother to nipple discomfort that otherwise can occur while frequently feeding her newborn throughout the day.

The nipple guard 1 includes a breast cup 3 having a size and shape to receive therewithin the front of the mother's breast. First and opposite ends of a cup-retaining strap 5 are connected to the breast cup 3 at the top and one side thereof. During use, the cup-retaining strap 5 runs under one arm of the mother, behind her back, and around a side of her neck to hold the cup 3 in surrounding engagement with one of her breasts. To this end, the strap 5 is preferably manufactured from an elastic material that is adapted to stretch so as to be capable of fitting around the bodies of most mothers. The elastic nature of the strap 5 applies a pulling force to retain the breast cup 3 in place over and against the mother's breast. In this regard, the cup-retaining strap 5 advantageously allows a hands-free use of the nipple guard 1.

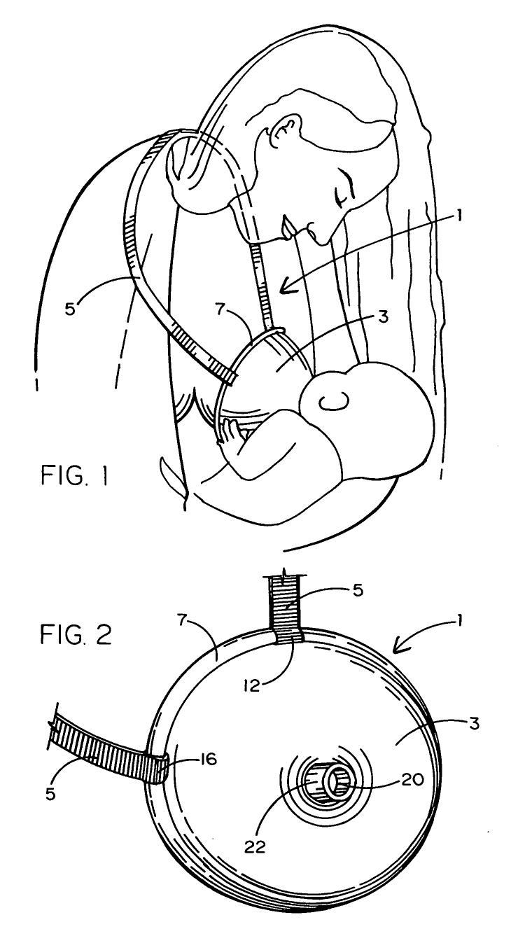

Details of the nipple guard 1 are now disclosed while referring concurrently to FIGS. 2-5 of the drawings. The breast cup 3 of nipple guard 1 is preferably manufactured from a flexible material such as, for example, a thin, pliable silicone, medical grade and hypo-allergenic material or that commonly known as Latex. The breast cup 3 is surrounded by a peripheral ring 7 that lies against the mother's breast. The peripheral ring 7 is preferably manufactured from a resilient foam or a soft rubber material to minimize the pressure applied to the breast in response to the pulling force generated by the cup-retaining strap 5 against cup 3. The peripheral ring 7 may be filled air or with a cushion material.

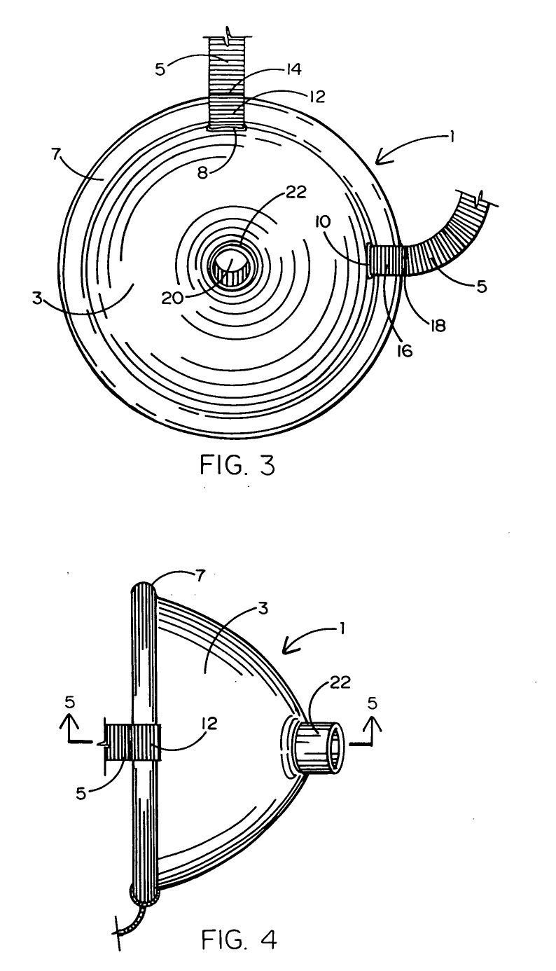

As is best shown in FIG. 3, a pair of small slits 8 and 10 are made through the top and one side of the nipple guard 1 at the intersection of the peripheral ring 7 with breast cup 3. A first end of the cup-retaining strap 5 is fed through a first of the pair of slits 8 and then turned back upon itself to form a first loop 12 around the peripheral ring 7. The loop 12 is closed by means of stitching 14, or the like. The opposite end of the cup-retaining strap 5 is fed through the second of the pair of slits 10 and then turned back upon itself to form a second loop 16 around peripheral ring 7. The loop 16 is closed by means of stitching 18, or the like. Accordingly, the first and opposite ends of strap 5 are connected to nipple guard 1 via the pair of slits 8 and 10 therethrough. Rather than attach the cup-retaining strap 5 to the nipple guard 1 at the slits 8 and 10 as shown, it is within the scope of this invention for strap 5 to be bonded directly to the peripheral ring 7 around breast cup 3.

A hole 20 is formed through the approximate center of the breast cup 3 of nipple guard 1. The hole 20 is sized to accommodate the mother's nipple therepast. A cylindrical sucking tube 22 is co-extensively connected to and projects outwardly from the breast cup 3 so as to communicate with the hole 20. The inside diameter of the hole 20 and cylindrical tube 22 are substantially identical. The tube 22 must be sufficiently long and wide to surround and protect the mother's nipple but short enough such that a natural sucking force generated by the newborn will be applied to the nipple to allow the newborn to nurse. Therefore, different nipple guards having tubes of correspondingly different lengths may be necessary for use by different mothers.

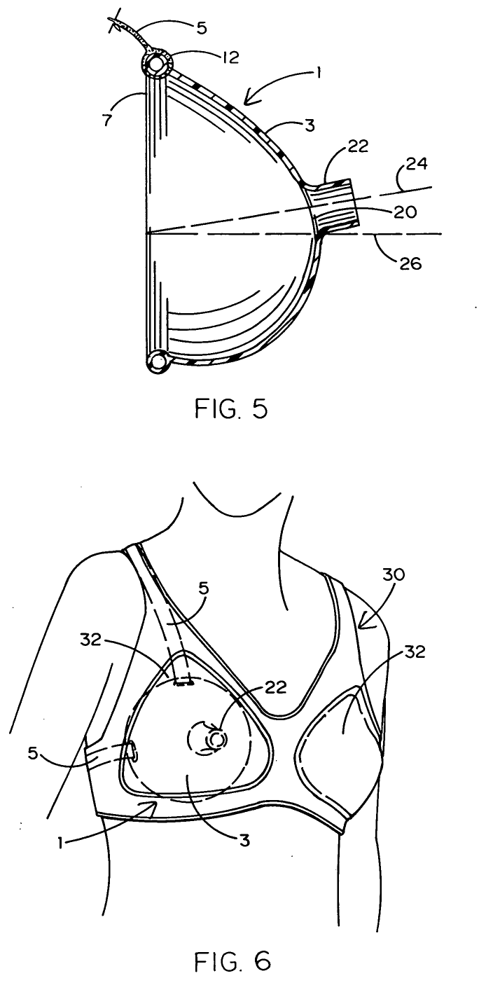

As is best shown in FIG. 5, the cylindrical tube 22 which surrounds the mother's nipple has a longitudinal axis 24 that makes a small angle of about 10 degrees with a transverse centerline 26 through the breast cup 3 of nipple guard 1. That is to say, the axis of tube 22 is offset from the centerline 26 in order to be aligned to receive the mother's nipple by way of the hole 20 in breast cup 3. Thus, it may be appreciated that the nipple guard 1 is tailored to fit over and around the mother's breast with the outwardly projecting cylindrical tube 22 thereof being angled and positioned on the breast cup 3 to correspond with the normal angle and position of the mother's nipple relative to her breast.

The nipple guard 1 of this invention is ideally suited to be used in combination with a conventional nursing bra of the kind often used by many nursing mothers. FIG. 6 of the drawings shows the nipple guard 1 being worn under a nursing bra 30 having a pair of removable or drop-down flaps 32. In this case, the breast cup 3 of nipple guard 1 fits below one of the flaps 32 of nursing bra 30. The tube 22 of nipple guard 1 must be sufficiently long to be able to pass through the open area created when the flap 32 is removed or pulled down from the nursing bra 30 so as to be accessible to receive a sucking force generated by the newborn. By virtue of the foregoing, the mother's comfort can be enhanced without subjecting her to significant inconvenience.

1. A combination comprising:
a nipple guard including a breast cup to fit over the breast of a nursing mother, said breast cup having an opening formed therein to receive the mother's nipple therepast so as to be accessible to a nursing child; and
a cup retaining strap attached to said nipple guard to apply a pulling force thereto and thereby hold said breast cup against the mother's breast, such that the mother's nipple is received through the opening in said breast cup.

2. The combination recited in claim 1, wherein said cup retaining strap has first and opposite ends, the first end of said cup retaining strap attached to said nipple guard at the top of said breast cup, and the opposite end attached to said nipple guard at one side of said breast cup.

3. The combination recited in claim 1, wherein said cup retaining strap is of sufficient length to travel completely around the back of the nursing mother against whose breast the breast cup of said nipple guard is held.

4. The combination recited in claim 1, wherein said nipple guard also includes a peripheral ring surrounding said breast cup and being manufactured from a resilient material, said peripheral ring extending around and lying against the breast of the nursing mother to cushion the pulling force generated by said cup retaining strap and applied to said breast cup against the mother's breast.

5. The combination recited in claim 1, wherein said nipple guard also includes a tube extending from said breast cup and communicating with said opening formed therein to surround the nipple of the nursing mother extending past said opening.

6. The combination recited in claim 5, wherein said tube is a cylinder having a longitudinal axis that makes an angle with a transverse centerline through the breast cup of said nipple guard.

7. A combination comprising:
a nipple guard including a breast cup to fit over the breast of a nursing mother, said breast cup having an opening formed therein to receive the mother's nipple therepast so as to be accessible to a nursing child; and
a nursing bra having an open area and a removable flap covering said open area and positioned so as to lie over the breast cup of said nipple guard, such that the open area of said nursing bra is aligned with the opening formed in the breast cup of said nipple guard, whereby the nipple of a nursing mother is received through each of said opening and said open area when said removable flap is removed from the open area.

8. The combination recited in claim 7, wherein said nipple guard also includes a protective tube projecting from said breast cup and communicating with said opening formed therein so as to extend through the open area of said nursing bra when said removable flap is removed from the open area, said tube being sized to surround the nipple of the nursing mother.

9. The combination recited in claim 8, further comprising a cup retaining strap attached to said nipple guard and sized to run completely around the back of the nursing mother so as to apply a pulling force thereto and thereby hold the breast cup of said nipple guard against the mother's breast, such that the mother's nipple is received through the opening and the protective tube of said nipple guard.
